(19) United States
(12) Patent Application Publication
(10) Pub. No.: US 2011/0192747 A1
(43) Pub. Date: Aug. 11, 2011

(54) METHOD FOR PRODUCING A BAG-LIKE STORAGE CONTAINER FOR CUT FLOWERS

(76) Inventor: Heinz-Dieter SCHMIDT, Windeck-Dattenfeld (DE)

(21) Appl. No.: 13/022,903

(22) Filed: Feb. 8, 2011

(30) Foreign Application Priority Data
Feb. 8, 2010 (CH) CH-00154/10

(51) Int. Cl. B65D 85/50; B31B 1/00

(52) U.S. Cl. 206/423; 493/267

(57) ABSTRACT

A method for producing a bag-like storage container for cut flowers comprising a flexible cover of a water-impermeable thermoplastic film and an inner coating of an absorbent material is described. The absorbent material thereby forms a soakable water reservoir for the cut flowers. The absorbent material is covered by a water-permeable cover layer of thermoplastic plastic, wherein the water-impermeable thermoplastic film is folded over the inner coating of soakable material towards the inside in the area of a bag opening and is connected to the cover layer at least on one side in the fold-over area. The method includes a method step, in the case of which a welding is carried out along longitudinal edges (6a, b) such that two layers of the water-permeable cover layer are located between two layers of the water-impermeable film in the area of welding seams (7).

### CROSS REFERENCE TO RELATED APPLICATIONS

This application claims priority under 35 U.S.C. §119 to Swiss Patent Application No. CH-00154/10 filed Feb. 8, 2010, the entire contents of which are incorporated herein by reference.

### FIELD OF THE INVENTION

The invention relates to a method for producing a bag-like storage container for cut flowers as well as to a bag-like storage container for cut flowers, which is produced with this method.

### BACKGROUND OF THE INVENTION

The invention relates in particular to a method for producing a bag-like storage container for cut flowers comprising a flexible cover of a water-impermeable thermoplastic film and an inner coating of an absorbent material, wherein the absorbent material forms a soakable water reservoir for the cut flowers. The soakable material is thereby covered by a water-permeable cover layer of thermoplastic plastic and the water-impermeable thermoplastic film is folded over the inner coating of soakable material towards the inside in the area of a bag opening and is connected to the cover layer at least on one side in the fold-over area.

Such a storage container for cut flowers is known from EP 0 625 117. The document shows an embodiment, in the case of which the flexible cover consists of a water-impermeable, preferably non-slip and tear-resistant and biodegradable material. The absorbent material preferably consists of cellulose, in particular cotton-like cellulose, but provision is also made for other materials, such as foam or spongy substances. The water-impermeable cover is thereby folded over the absorbent material in the area of a bag opening, so as to form a drain, which is to prevent an outflow of the water when the bouquet of flowers is held upside down. The layer of absorbent material is covered towards the inside by means of a porous or perforated film. This porous film can consist of a plastic comprising small holes, but nonwovens in the manner of a geotextile or a fine fabric are also suitable. The porous film is thereby fixedly connected to the edge of the water-impermeable cover on the inside by means of the fold-over in the area of the bag opening by means of adhesion or welding.

The manner of production of the storage container for cut flowers is not disclosed in EP 0 625 117. However, it is known that the above-mentioned material layers are placed on top of one another and that a mutual welding of the water-impermeable cover is subsequently carried out on both sides along longitudinal edges in the case of storage containers for cut flowers, which are designed in the same or in a similar manner, for instance in the case of the “freshbag” products of Rotaris Marketing GmbH. It goes without saying that such welding is only possible in the case of thermoplastic materials, and they also require that no non-weldable materials are located between the two cover layers, which are to be welded. Generic storage containers are thus also produced in such a manner that neither the absorbent material nor the cover layer, which covers the absorbent material, extends to areas of the water-impermeable flexible cover, in which the welding seams come to rest. However, it turned out that irregularities of the welding seam run appear easily at the welding seams, due to the very small layer thicknesses of the flexible covers, and thus consequently also resulting in small holes and leaks. It goes without saying that water, which runs out of such leaks is perceived as being unpleasant.

### SUMMARY OF THE INVENTION

It is thus the object of the invention to specify a method for producing a bag-like storage container for cut flowers, which no longer encompasses the mentioned disadvantages. In addition, a bag-like storage container for cut flowers, which is produced according to the new method, by means of which the handling is also improved during use, is to also be specified.

The method according to the invention is based on that the semi-finished product, also referred to as “semifinished product” hereinbelow, is welded along longitudinal edges such that two layers of the water-permeable cover layer are located between two layers of the water-impermeable film in the area of the welding seam. Due to the fact that provision is made to produce the water-impermeable flexible cover as well as the water-permeable cover layer of thermoplastic, weldable materials, the result is a larger overall thickness in the area of the welding seams, which leads to a smaller susceptibility against irregularities in response to the welding process.

Due to the fact that, as mentioned above, the absorbent material can be available in individual layers, which hold together (e.g. cellulose layers), as well as in layers of flaky material (e.g. cotton-like cellulose), which holds together only very loosely, it can be useful, simply for reasons of the material handling during the work preparation process, to provide for a cover or separating layer on both sides of the absorbent material. The afore-mentioned improvement of the welding seam quality by increasing the overall thickness in the welding seam area could also be further increased by additionally using a thermoplastic separating layer. An improvement in the handling during the production process by reducing the flaking along cutting edges, however, can be achieved at any rate in this manner.

Finally, an opening aid can be attached to both outer sides of the bag-like storage means in a further method step or in a plurality of further method steps. The opening aid can thereby be embodied as a strap, as a finger strap or as a finger bag. An opening aid, which is embodied in such a manner, allows for the bag-like storage container according to the invention for cut flowers to be opened with only one hand to the extent that water or cut flowers can be added with the other hand. An exemplary embodiment of the method according to the invention for producing a bag-like storage container for cut flowers will be described below by means of figures.

### BRIEF DESCRIPTION OF THE DRAWINGS

FIGS. 1a and b show a first method step,

FIG. 2a and b show a second method step,

FIG. 3a and b show a third method step,

FIG. 4a and b show a fourth and fifth method step,

FIG. 5a and b show a sixth and seventh method step in the production of the bag-like storage container, and

FIG. 6a and b show the bag-like storage container after the attaching of an opening aid on both outer sides.

### DETAILED DESCRIPTION OF THE INVENTION

FIGS. 1 to 5 show the individual method steps for producing a bag-like storage container for cut flowers, namely in a top view (a) and in a longitudinal section (b) for each method step. The illustrations are not to scale.

According to FIGS. 1a and 1b, a first rectangular molded part of water-impermeable film 1 is provided in a first method step. FIG. 1b thereby shows a longitudinal section along a sectional line A-A. The water-impermeable film 1 consists of a thermoplastic, weldable, thin and flexible material, such as polyethylene (PE), for example.

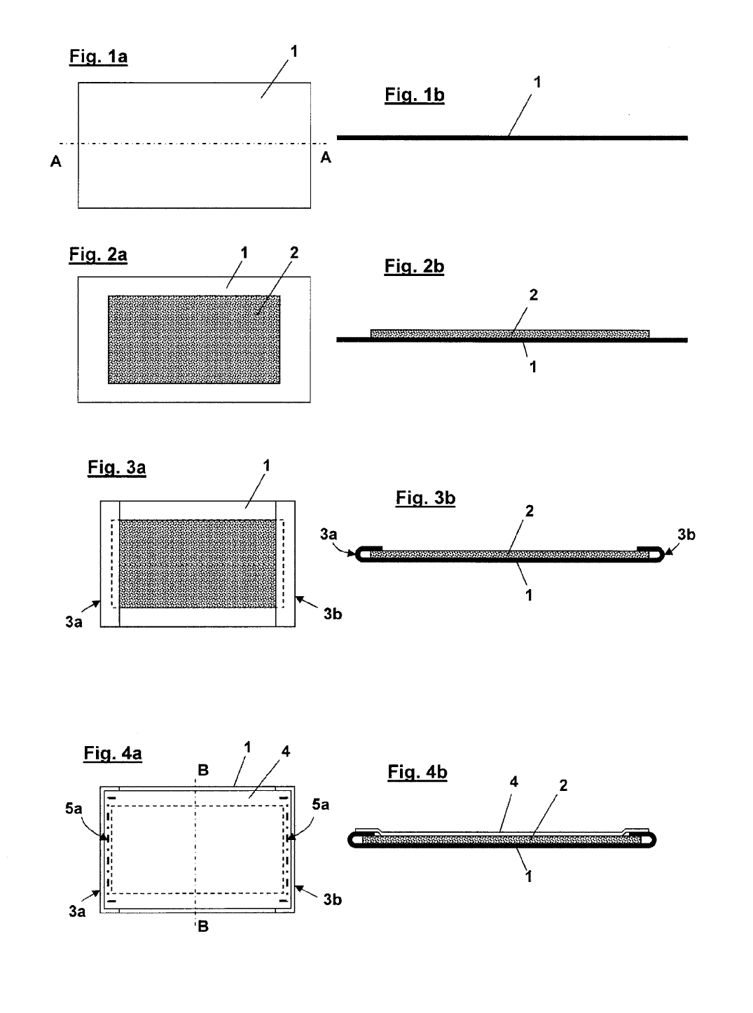

According to FIGS. 2a and 2b, a second rectangular molded part of absorbent material 2 is provided and is placed onto the water-impermeable film 1 in a second method step, wherein the second molded part has the same geometry, but is smaller than the first molded part to the extent that a circumferential edge, which remains open, of the water-impermeable film 1 remains. The absorbent material 2 is a cellulose mat, for example, or a cotton-like cellulose, but other materials, such as foam or spongy substances, are also possible.

According to FIGS. 3a and 3b, the water-impermeable film 1 is folded over the inner coating of absorbent material 2 on two transverse edges 3a, b located opposite one another in a third method step.

According to FIGS. 4a and 4b, a third rectangular molded part of water-permeable cover layer 4 consisting of thermoplastic plastic is placed in a substantially covering manner over the absorbent material 2, which is provided in the preceding steps, as well as over the parts of the water-impermeable film 1, which are folded over and those that are not folded over, in a fourth method step. The water-permeable cover layer is made of a net-like, thermoplastic, weldable, thin and flexible material, such as polyethylene (PE) or polypropylene (PP), for example, and can be available as a thin nonwoven layer.

According to FIG. 4a, the water-permeable cover layer 4 comprising the water-impermeable film 1 is fastened at least to the two transverse edges 3a, b of the first molded part located opposite one another according to FIG. 4a. The respective fastening regions 5a, b are identified by means of dash-dotted lines. This fastening can be carried out by means of adhesion or welding. The semi-finished product created in such a manner will be referred as semifinished product hereinbelow. It goes without saying that the fastening regions could also extend all around the absorbent material 2, but this should not be necessary, because a mutual relative displacement of the water-impermeable film 1, of the absorbent material 2 and of the water-permeable cover layer can already be avoided by means of the specified type of fastening.

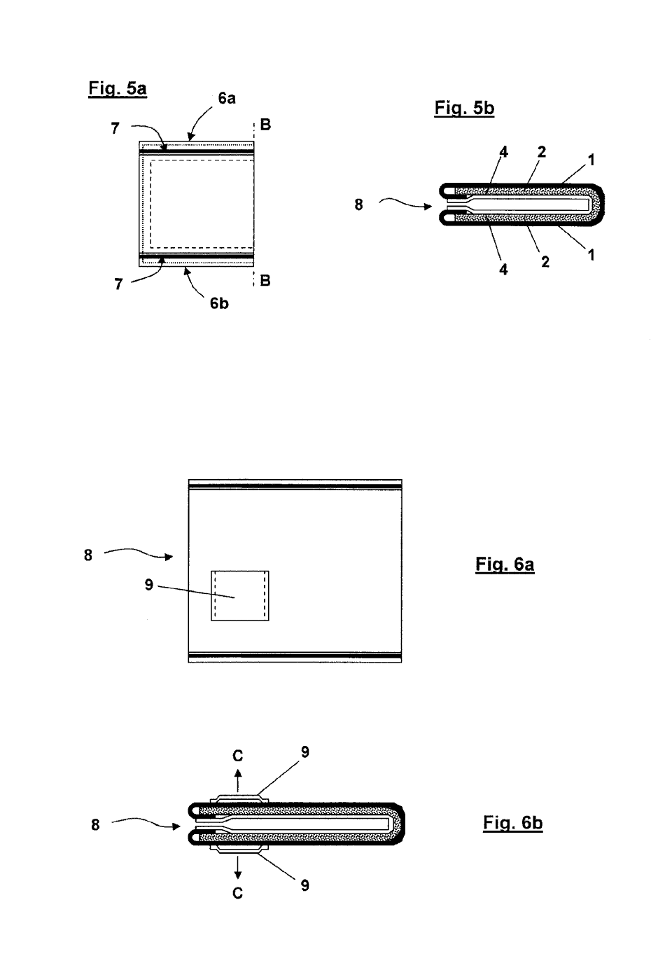

According to FIGS. 4a, 5a and 5b, the semifinished product is folded along a center line B-B such that the water-permeable cover layers 4 touch one another in a sixth method step.

In a seventh method step, the folded semifinished product is welded along longitudinal edges 6a, b such that two layers of the water-permeable cover layer 4 are located between two layers of the water-impermeable film 1 on both sides in the area of a welding seam 7. This is substantially the case even in the case of the folded-over areas in the vicinity of a bag opening 8 according to the third method step. It is thus ensured that the desired improvement of the welding seam quality is attained by increasing the overall thickness in the welding seam area.

As was already mentioned, the absorbent material 2, which is used in the second method step, can be available in the individual layers (e.g. as cellulose layers), which hold together, as well as in a layer of flaky material (e.g. cotton-like cellulose), which holds together only very loosely. Flaky or cotton-like material, however, often has a relatively poor material cohesion, which is why it may be sensible to provide for a cover or separating layer on both sides of the absorbent material to improve the handling. This could in particular be the case when the absorbent material is processed separately. With reference to the above-described method, the result would be the same if one were to place a separating layer (not illustrated) onto the water-impermeable film prior to the second method step. For this separating layer, there are no limitations with reference to the material selection, it can thus also be a simple paper or cellulose layer, for example.

It can furthermore be possible for the fastening in the fifth method step to be carried out by means of an adhesive method or by means of a welding method. Due to the fact that the water-impermeable film 1 as well as the water-permeable cover layer 4 consists of thermoplastics, welding methods can also be used.

Finally, it is also possible to attach opening aids to both outer sides of the bag-like storage means in one or in a plurality of further method steps. Openings aids are means, which are to facilitate the opening of the bag-like storage container for cut flowers manually or to keep it open, preferably using only one hand, so that water can be poured in or flowers can be added, for example, with the other hand. It goes without saying that such opening aids are not to impact the integrity of the water-impermeable film 1, because the efforts of preventing undesired outflow of water in the case of a packaged bouquet of flowers, would otherwise be undone again.

Finally, it is also possible to add preservatives to the absorbent material (2). Preferably, this takes place prior to the second method step, thus before the absorbent material (2) is placed onto the water-impermeable film (1). This has the advantage that all molded parts can be provided in a preassembled manner for the production of the bag-like storage container.

However, belts attached on both sides, for example, can also be considered to be openings means in the general sense. Even though they are not suitable for one-handed use, they do, however, allow for the bouquet of flowers to be tied closed.

FIGS. 6a and 6b show a bag-like storage container according to the invention for cut flowers comprising opening aids, which can be used with one hand, in the form of finger straps 9. These finger straps 9 are attached to the storage container on both sides in the area of the bag opening 8. For this purpose, a further small molded part of the same material as the water-impermeable film 1, for example, can be adhered or welded on each side. During use, thumb and index finger of one hand are inserted into the finger straps 9 and the bag opening 8 is pulled apart in the opening directions C.

It goes without saying that the bag according to the invention can not only be used for storing cut flowers, but for example also for storing and keeping vegetables fresh, such as asparagus and the like.

### LIST OF REFERENCE NUMERALS

1 water-impermeable film
2 absorbent material
3a, b transverse edges
4 water-permeable cover layer
5a, b fastening regions
6a, b longitudinal edges
7 welding seam
8 bag opening
9 finger straps
A-A sectional line (in longitudinal direction)
B-B center line (in transverse direction)
C, C opening direction

1. A method for producing a bag-like storage container for cut flowers comprising a flexible cover of a water-impermeable thermoplastic film (1) and an inner coating of an absorbent material (2), wherein the absorbent material (2) forms a soakable water reservoir for the cut flowers and is covered by a water-permeable cover layer (4) of thermoplastic plastic, and wherein the water-impermeable thermoplastic film (1) is folded over the inner coating of soakable material (2) towards the inside in the area of a bag opening (8) and is connected to the cover layer (4) at least on one side in the fold-over area,
wherein
a first rectangular molded part of water-impermeable film (1) is provided in a first method step,
a second rectangular molded part of absorbent material (2) is provided and is placed onto the water-impermeable film (1) in a second method step, wherein the second molded part has the same geometry, but is smaller than the first molded part to the extent that a circumferential edge, which remains open, of the water-impermeable film (1), remains,
the water-impermeable film (1) is folded over the inner coating of absorbent material (2) on two transverse edges (3a, b) in a third method step,
a third rectangular molded part of water-permeable cover layer (4) consisting of thermoplastic plastic is fastened in a substantially covering manner over the absorbent material (2), which is provided in the preceding steps, as well as over the parts of the water-impermeable film (1), which are folded over and those that are not folded over, at least on the two transverse edges (3a, b) of the first molded part located opposite one another in a fourth method step, so that a semifinished product is created,
the semifinished product is folded along a center line (B-B) such that the water-permeable cover layers (4) touch one another in a sixth method step and
the folded semifinished product is welded along longitudinal edges (6a, b) such that two layers of the water-permeable cover layer (4) are located between two layers of the water-impermeable film (1) in the area of welding seams (7) in a seventh method step.

2. The method according to patent claim 1, wherein a separating layer is placed onto the water-impermeable film (1) prior to the second method step.

3. The method according to patent claim 1, wherein a freshness-retaining agent is added to the absorbent material (2) prior to the second method step.

4. A method according to patent claim 1, wherein an adhesion or a welding method is used in the fifth method step.

5. The method according to patent claim 1, wherein opening aids are attached to both outer sides of the bag-like storage means in one method step or in a plurality of further method steps.

6. The method according to patent claim 2, wherein opening aids are attached to both outer sides of the bag-like storage means in one method step or in a plurality of further method steps.

7. The method according to patent claim 3, wherein opening aids are attached to both outer sides of the bag-like storage means in one method step or in a plurality of further method steps.

8. The method according to patent claim 4, wherein opening aids are attached to both outer sides of the bag-like storage means in one method step or in a plurality of further method steps.

9. A bag-like storage container for cut flowers, produced according to the method according to patent claim 5, wherein opening aids, which can be operated with one hand, are available in the area of the bag opening.

10. The bag-like storage container according to patent claim 9, wherein the opening aid is embodied as strap, as finger strap (9) or as finger bag.

11. The bag-like storage container according to patent claim 9, wherein the absorbent material (2) is permeated by a freshness-retaining agent.
